(19) United States
(12) Patent Application Publication
(10) Pub. No.: US 2026/0012543 A1
(43) Pub. Date: Jan. 8, 2026

(54) DOCUMENT-READING SYSTEM

(71) Applicant: CANON KABUSHIKI KAISHA, Tokyo (JP)

(72) Inventor: MASANORI HIRONISHI, Tokyo (JP)

(21) Appl. No.: 19/254,752

(22) Filed: Jun. 30, 2025

(30) Foreign Application Priority Data
Jul. 5, 2024 (JP) 2024-109089

(51) Int. Cl. H04N 1/00; H04N 1/40

(52) U.S. Cl. CPC H04N 1/00034; H04N 1/00005; H04N 1/00074; H04N 1/00442; H04N 1/00482; H04N 1/40012; H04N 2201/0081

(57) ABSTRACT

There is provided a document-reading system including: a reading unit configured to read a document and generate read image data; a first determination unit configured to determine whether a numerical measure that is based on a color of a pixel of the read image data is within a predetermined range; and a second determination unit configured to determine whether the document is to be processed as a colored document or a colorless document. The second determination unit is configured to, based on a user input, perform determination in a first or second mode. In the first mode, an inquiry to a user is made as to whether to process the document as a colored document or a colorless document when the first determination unit has determined that the numerical measure is within the range. In the second mode, no inquiry is made.

### BACKGROUND

### Field of the Technology

The present disclosure relates to a document-reading system.

### Description of the Related Art

A known function called automatic color selection (ACS) automatically selects whether a document is a colored document (color document) or a colorless document (monochrome document) on the basis of read image data generated by a scanner reading a document.

Japanese Patent Laid-Open No. 2008-306396 discloses a technology which determines whether a document is colored or colorless by comparing the number of consecutive colored pixels in a sub-scanning direction with a threshold so that misalignment between colors due to a structure of a line sensor of a scanner does not cause the ACS to operate erroneously.

Japanese Patent Laid-Open No. 2018-129861 discloses a technology which determines whether each page of a document is colored or colorless on the basis of consecutiveness of colored pixels as in Japanese Patent Laid-Open No. 2008-306396, and includes a function for removing blank pages in which a user can configure whether to remove respective ones of colored blank pages and colorless blank pages.

Many known ACSs compare a certain numerical measure based on a color in read image data with a threshold to determine whether each document or each pixel is colored or colorless. However, in a case where the numerical measure indicates a value close to the threshold, an error is likely to occur in the colored/colorless determination. For example, when a colorless document is erroneously determined as a colored document, color printing is executed for a copy job suited to monochrome printing, leading to a user taking on more economical cost than required.

### SUMMARY

The technology according to the present disclosure provides a mechanism that can avoid the possibility that an error in a determination by the ACS causes a processing result that is contrary to an intention of a user.

According to an aspect, there is provided a document-reading system including: an operation unit configured to accept a user input; a reading unit configured to read a document and generate read image data; a first determination unit configured to determine whether a numerical measure that is based on a color of a pixel of the read image data is within a predetermined range; and a second determination unit configured to determine whether the document is to be processed as a colored document or a colorless document, wherein the second determination unit is configured to, based on a user input accepted by the operation unit, perform determination in a first mode in which an inquiry to a user is made as to whether to process the document as a colored document or a colorless document in a case where the first determination unit has determined that the numerical measure is within the range or in a second mode in which whether to process the document as a colored document or a colorless document is determined without making the inquiry.

Features of the present disclosure will become apparent from the following description of embodiments with reference to the attached drawings. The following description of embodiments are described by way of example.

### BRIEF DESCRIPTION OF THE DRAWINGS

FIG. 1 is a configuration diagram illustrating an example of the schematic configuration of a document-reading system according to an embodiment.

FIG. 2 is a configuration diagram illustrating an example of a configuration of a scanner according to an embodiment.

FIG. 3 is a block diagram illustrating an example of a configuration relating to the control function of a document-reading system according to an embodiment.

FIG. 4 is an explanatory diagram of a first example of a configuration of a mode selection screen.

FIG. 5 is an explanatory diagram of a second example of a configuration of a mode selection screen.

FIG. 6 is a flowchart illustrating an example of a flow of job control processing according to a first embodiment example.

FIG. 7 is a flowchart illustrating an example of a flow of document reading processing according to the first embodiment example.

FIG. 8 is a flowchart illustrating an example of a flow of document reading processing according to a second embodiment example.

FIG. 9A is a first explanatory diagram of a third example of a configuration of a mode selection screen.

FIG. 9B is a second explanatory diagram of a third example of a configuration of a mode selection screen.

FIG. 10 is a flowchart illustrating an example of a flow of job control processing according to a third embodiment example.

FIG. 11 is an explanatory diagram of a fourth example of a configuration of a mode selection screen.

FIG. 12 is an explanatory diagram of an example of a configuration of an ACS settings screen.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Apparatus Overview

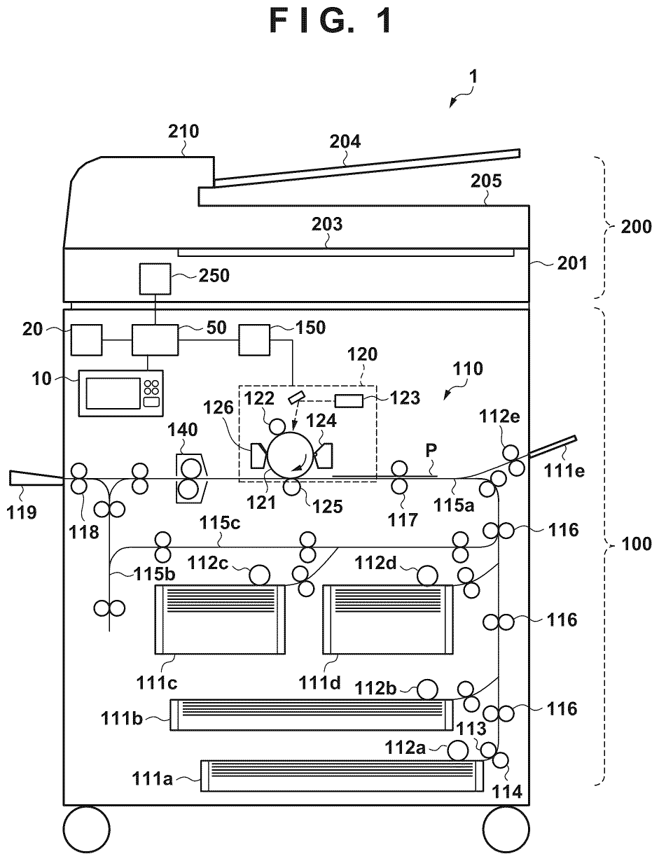

In the present section, an overview of a document-reading system 1 will be given as an example of a system to which the technology according to the present disclosure may be applied. FIG. 1 is a configuration diagram illustrating an example of a schematic configuration of the document-reading system 1 according to an embodiment. In the example of FIG. 1, the document-reading system 1 is a so-called multi-function peripheral. The document-reading system 1 includes an operation unit 10, a communication interface 20, a system controller 50, a printer 100, and a scanner 200. The scanner 200 may be disposed above the casing of the printer 100. The operation unit 10 may be disposed on one side surface of the casing of the printer 100.

### <1.1 Operation Unit>

The operation unit 10 provides a user interface (UI) to the user of the document-reading system 1. The operation unit 10 includes, for example, input devices such as a touch panel, a button, and a mouse and output devices such as a display, a light, and a speaker. The operation unit 10 accepts a user input via an input device. The operation unit 10 outputs information via an output device or displays images.

### <1.2 Communication Interface>

The communication interface 20 is an interface for the document-reading system 1 to communicate with an external apparatus via a network. The communication interface 20 may be a wired communication interface or may be a wireless communication interface.

### <1.3 System Controller>

The system controller 50 is a control unit for controlling all of the functions of the document-reading system 1. The system controller 50, in response to an instruction input via the operation unit 10 or the communication interface, cooperates with the printer 100 and the scanner 200 to control the execution of various jobs. For example, in a case where a copy job instruction is issued, the system controller 50 causes the scanner 200 to read a document and controls the printer 100 to form an image on a sheet on the basis of the read image data generated by a scanner controller 250. In a case where a print job instruction is issued, the system controller 50 controls the printer 100 to form an image on a sheet on the basis of the print image data received via the communication interface. In a case where a scan job instruction is issued, the system controller 50 causes the scanner 200 to read a document and stores the read image data in internal storage or transmits the read image data to an external apparatus via the communication interface. An example of a specific configuration of the system controller 50 will be further described below.

### <1.4 Printer>

The printer 100 is an image forming apparatus that forms an image on a sheet (referred to as a recording medium). In the present embodiment, an example of the printer 100 forming an image via electrophotography is mainly used. However, the technology according to the present disclosure is not limited to this example and may be applied to other examples in which the printer 100 operates using another image forming method such as the inkjet method. The printer 100 includes a conveying unit 110, an image forming unit 120, a fixing unit 140, and a printer controller 150. Note that in FIG. 1, only one image forming unit 120 is illustrated, but in practice, the printer 100 may include four image forming units 120 corresponding to four color components of yellow (Y), magenta (M), cyan (C), and black (K).

The conveying unit 110 includes cassettes 111a to 111d, a manual feed tray 111e, a plurality of rollers associated with feeding and conveying the sheets, conveying paths 115a to 115c, and a discharge tray 119. The cassettes 111a to 111d can contain a bundle of sheets of different sizes. Pickup rollers 112a to 112d pick up a sheet from a bundle of sheets contained in the corresponding cassette 111a to 111d and feeds the sheet to the conveying path 115a. A feeding roller 112e feeds the sheet placed on the manual feed tray 111e to the conveying path 115a. A feed roller 113 and a retard roller 114 separates one sheet being fed from the other to prevent sheet multi-feed. The sheet is conveyed along the conveying path 115a by a group of conveyance rollers 116 and reaches a registration roller pair 117. The registration roller pair 117 stop the leading end of a sheet P being conveyed, corrects the skew of the sheet P, and sends the sheet P to a transfer position in conjunction with the operation of the image forming unit 120 described below.

The image forming unit 120 includes a photosensitive drum 121, a charging device 122, an exposure device 123, a developing device 124, a transfer roller 125, and a cleaner 126. The photosensitive drum 121 is an image carrier that can rotate in the clockwise direction in the figure. The charging device 122 uniformly charges the surface of the photosensitive drum 121. The exposure device 123 exposes the surface of the photosensitive drum 121 using laser light according to image data input from the printer controller 150 and forms an electrostatic latent image on the surface of the photosensitive drum 121. The developing device 124 contains a developing agent (for example, a two-component developing agent including a toner and a carrier) and supplies the developing agent to the surface of the photosensitive drum 121 to develop the electrostatic latent image and form a toner image. The transfer roller 125 applies a bias voltage and transfers the toner image on the surface of the photosensitive drum 121 to the sheet P that has arrived at the transfer position. The cleaner 126 removes the toner remaining on the surface of the photosensitive drum 121.

In practice, in a case where the printer 100 operates in a color print mode, toner images of yellow, magenta, cyan, and black are transferred on top of one another in order onto the sheet P from the photosensitive drums 121 of the image forming units 120 corresponding to the four color components. In this manner, a full-color toner image is formed on the surface of the sheet P. On the other hand, in a case where the printer 100 operates in a monochrome print mode, a toner image is formed only on the photosensitive drum 121 of the image forming unit 120 corresponding to black, and the toner image is transferred to the sheet P. In this case, the toner of yellow, magenta, and cyan is not consumed.

The sheet P on which the toner image is transferred is further conveyed toward the fixing unit 140 disposed downstream of the transfer position. The fixing unit 140 fixes the toner image on the sheet P. The toner of the toner image is heated and melted by a heating roller of the fixing unit 140 and then bonded to the sheet by being pressed by a pressing roller. The roller pair of the fixing unit 140 pinches the sheet P and further conveys the sheet P downstream. A discharge roller pair 118 discharges the sheet P to the discharge tray 119 after completion of the image formation.

In the case of double-sided printing, the sheet P with a toner image formed on a first side is conveyed to a conveying path 115b. At the conveying path 115b, the traveling direction of the sheet P is reversed. The sheet P passes through a double-sided conveying path 115c and is returned to the conveying path 115a with the surfaces inverted. Then, when the sheet P arrives at the transfer position again, a toner image is transferred onto a second side of the sheet P. The fixing unit 140 fixes the toner image to the second side by heating and pressing the sheet P again. Then, the sheet P is discharged to the discharge tray 119.

The printer controller 150 controls the operation of each unit of the printer 100 so that the printer 100 forms images on sheets as described in the present section in accordance with instructions received from the system controller 50.

### <1.5 Scanner>

The scanner 200 is a document-reading apparatus that reads documents and generates read image data. In the present embodiment, the scanner 200 is constituted of a body 201 and a cover 202. The cover 202 is connected to the body 201 via a hinge and can open and close. When the user opens the cover 202, a platen 203 on the upper surface of the body 201 is exposed. The cover 202 includes a built-in ADF 210 described below. Thus, the scanner 200 is capable of successively reading a plurality of documents. The document to be read by the scanner 200 is placed on the platen 203 by the user or set on a document tray 204. The ADF 210 conveys the document set on the document tray 204 along an internal conveying path and discharges the document to a discharge tray 205. A line sensor 225 described below optically reads the document placed on the platen 203 or a document conveyed by the ADF 210. An example of a more detailed configuration of the scanner 200 will be further described in the next section.

### 2. Detailed Configuration of Scanner

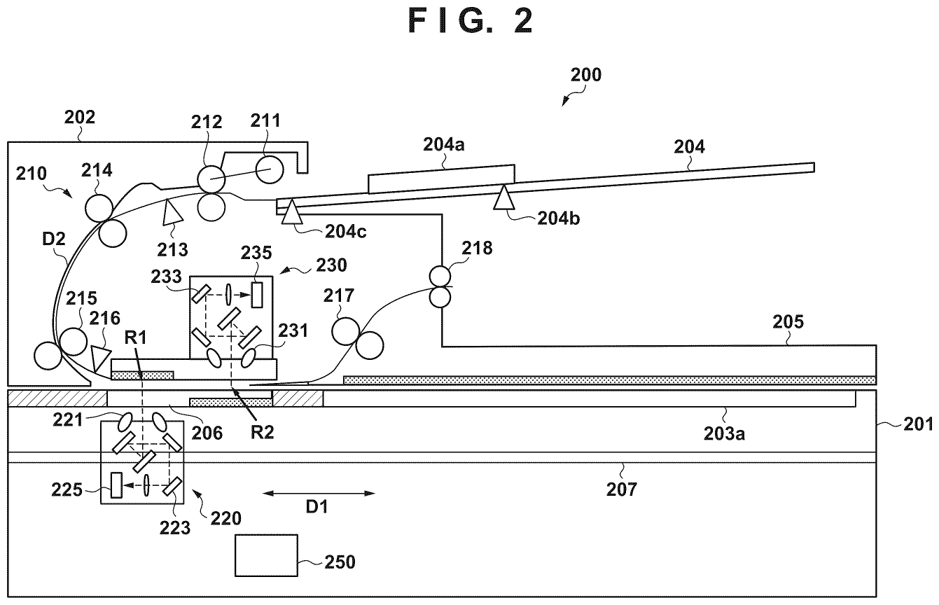

FIG. 2 is a configuration diagram illustrating an example of a configuration of the scanner 200 according to an embodiment. As illustrated in FIG. 2, the body 201 includes a platen glass 203a, a feeding-reading glass 206, a guide 207, a first reading unit 220, and the scanner controller 250. The cover 202 includes the document tray 204, the discharge tray 205, the ADF 210, and a second reading unit 230. The document tray 204 includes a pair of regulating plates 204a, a width sensor 204b, and a document sensor 204c. The ADF 210 includes several rollers and sensors involved in document conveyance that are disposed along a conveying path D2.

In the case of reading a document set on the platen 203, the scanner controller 250 causes the first reading unit 220 to move in the sub-scanning direction (direction D1 in the figure) along the guide 207 via the driving force of a guide motor (not illustrated). The first reading unit 220 includes an LED 221, an optical system 223, and the line sensor 225. The LED 221 emits light at the document. The optical system 223 includes a plurality of lenses and mirrors and focuses the light reflected at the first side of the document (front surface) on a light-receiving surface of the line sensor 225. The line sensor 225 is a collection of image sensors arranged per pixel in the main scanning direction (depth direction in the figure). The image sensor here may be a photoelectric conversion element such as a charge coupled device (CCD), for example. Alternatively, a contact image sensor (CIS) may be used instead of a CCD. The line sensor 225, while the first reading unit 220 is moving in the sub-scanning direction, reads the light from the first side of the document one line at a time to generate a read image of the first side.

When the user sets one or more documents on the document tray 204, the user may adjust the position of the regulating plates 204a so that the gap between the regulating plates 204a matches the width of the document in the main scanning direction. The width sensor 204b detects the width of the set document on the basis of the position of the adjusted regulating plates 204a. The document sensor 204c detects that a document has been set on the document tray 204. In the case of reading a document conveyed by the ADF 210, the scanner controller 250 drives a conveyance motor (not illustrated) to rotate the rollers of the ADF 210. A pickup roller 211 comes into contact with the upper surface of the document bundle and conveys the documents one sheet at a time to the conveying path D2. A separation roller pair 212 separates the fed document sheet from the remaining document sheets.

A separation sensor 213 detects the leading end and the trailing end of the document conveyed along the conveying path D2. The length of the document can be determined from the time difference of the detection of the leading end and the trailing end of the document by the separation sensor 213. Document skew is corrected by the leading end of the document hitting a nip position of a registration roller pair 214. The registration roller pair 214 conveys the document further downstream toward a first reading position R1. A read upstream roller pair 215 and a read sensor 216 are arranged downstream of the registration roller pair 214. The read sensor 216 detects the leading end of the document. The scanner controller 250 determines the timing to start the reading of the document by the first reading unit 220 (and the second reading unit 230) on the basis of the timing at which the read sensor 216 detected the leading end of the document.

The read upstream roller pair 215 send the document to the first reading position R1. The feeding-reading glass 206 is arranged below the first reading position R1, and the first reading unit 220 is positioned below the feeding-reading glass 206. The line sensor 225 of the first reading unit 220, while the document is passing through the first reading position R1, reads the light emitted from the LED 221 and reflected at the first side of the document one line at a time to generate a read image of the first side. Thereafter, the document passes through a second reading position R2.

The second reading unit 230 is located above the second reading position R2. In the case of an instruction to read both sides, in addition to the first reading unit 220, the second reading unit 230 also executes reading. The second reading unit 230 includes an LED 231, an optical system 233, and a line sensor 235. The LED 231 emits light at the document. The optical system 233 includes a plurality of lenses and mirrors and focuses the light reflected at the second side of the document (back surface) on a light-receiving surface of the line sensor 235. The line sensor 235 is a collection of image sensors arranged per pixel in the main scanning direction. The line sensor 235, while the document is passing through the second reading position R2, reads the light reflected at the second side of the document one at a time to generate a read image of the second side. After the document has passed the second reading position R2, the document is conveyed further downstream by a read downstream roller pair 217 and is discharged to the discharge tray 205 by a discharge roller pair 218.

The photoelectric conversion elements of the light-receiving surface of the line sensor 225 of the first reading unit 220 and the line sensor 235 of the second reading unit 230 convert the received light into electrical signals, which will constitute an analog image signal representing a read image. The line sensors 225 and 235 are each mounted on a sensor substrate (not illustrated). The analog image signal is output from the sensor substrate to the scanner controller 250 and converted by an analog-digital converter (ADC) described below into read image data of a digital format.

### 3. Configuration of Control Function

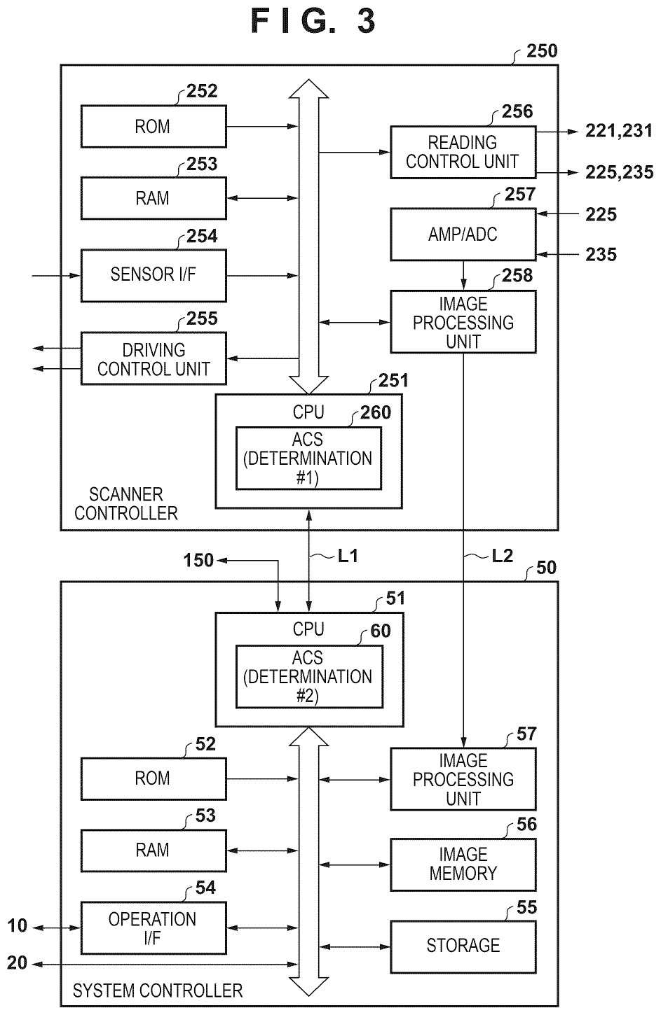

In the present section, an example of a configuration relating to the control function of the document-reading system 1 will be described focusing on the system controller 50 and the scanner controller 250 in particular. FIG. 3 is a block diagram illustrating an example of a configuration relating to the control function of the document-reading system 1.

### <3.1 Scanner Controller>

As illustrated in FIG. 3, the scanner controller 250 includes a CPU 251, ROM 252, RAM 253, a sensor I/F 254, a driving control unit 255, a reading control unit 256, an AMP/ADC 257, and an image processing unit 258.

The CPU 251 controls the reading operations of the scanner 200 by executing a control program stored in the ROM 252. The CPU 251 is connected to the system controller 50 via a control signal line L1. The RAM 253 provides the CPU 251 with a temporary storage area for computations.

The sensor I/F 254 is an interface for connecting the various sensors of the scanner 200 to the scanner controller 250. For example, in the case of feeding-reading, the signals input from the width sensor 204b and the separation sensor 213 may be used for determining the size of the document, that is, the width and length of the document. Also, the document detection signals input from the read sensor 216 may be used for determining the timing for the line sensors 225 and 235 to execute reading.

The driving control unit 255 controls the movement in the direction D1 of the first reading unit 220 and the conveyance of the document along the conveying path D2 of the ADF 210. Also, the reading control unit 256 controls the reading of the document by the line sensor 225 of the first reading unit 220 and the line sensor 235 of the second reading unit 230. The driving control unit 255 and the reading control unit 256 can cause the first reading unit 220 (and the second reading unit 230) to successively read a plurality of documents in the case of feeding-reading.

For example, in the case of reading documents placed on the platen 203, the driving control unit 255 controls the driving of the guide motor so that the first reading unit 220 moves in the sub-scanning direction at a predetermined movement speed. The reading control unit 256 causes the LED 221 to turn on and emit light on the first side of the document while the first reading unit 220 is moving below the platen glass 203a. The reading control unit 256 causes the line sensor 225 to read each line of the first side of the document in an interval corresponding to a designated read resolution.

Also, in the case of feeding-reading, the driving control unit 255 controls driving of the actuators, such as the conveyance motor and the clutch, of the ADF 210 so that the rollers of the ADF 210 convey the documents along the conveying path D2 at appropriate timings. The reading control unit 256, while a document is passing through the first reading position R1, causes the LED 221 to turn on and emit light at the first side of the document. The reading control unit 256 causes the line sensor 225 to read each line of the first side of the document at the timing when each line passes the first reading position R1. Also, in the case of an instruction to read both sides, the reading control unit 256, while the document is passing through the second reading position R2, causes the LED 231 to turn on and emit light at the second side of the document. The reading control unit 256 causes the line sensor 235 to read each line of the second side of the document at the timing when each line passes the second reading position R2. The reading control unit 256 measures the movement distance of the document by counting periodic pulses of a pulse signal output from the rotating conveyance motor, for example. Also, on the basis of the movement distance of the document from the point in time when the leading end of the document is detected by the read sensor 216, the reading control unit 256 can issue instructions to turn on and perform reading to the LEDs 221 and 231 and the line sensors 225 and 235 at the appropriate timing.

The AMP/ADC 257 is a combination of a signal amplification circuit and an analog-digital conversion circuit. The AMP/ADC 257 amplifies the analog image signal input from the line sensors 225 and 235, executes AD conversion on the amplified signal, and outputs read image data in a digital format to the image processing unit 258. The read image data, for example, includes a pixel set corresponding to the read size of the document including three color components of red (R), green (G), and blue (B). For example, each pixel value may be expressed using 8 bits, and in this case, each pixel value indicates a tone in the range of 0 to 255.

The image processing unit 258 executes image processing including, for example, noise removal, resolution conversion, skew correction, and shading correction on the read image data. The scanner controller 250 may include a shading circuit separate from the image processing unit 258. The image processing unit 258 is connected to the system controller 50 via an image signal line L2 and outputs the read image data to the system controller 50 in response to an instruction from the CPU 251.

In the present embodiment, the CPU 251 cooperates with a CPU 51 of the system controller 50 described below and provides an ACS function to determine whether to process the document read by the scanner 200 as a colored document or a colorless document. For the ACS function, the CPU 251 operates as a first determination unit 260. The ACS function will be described in detail below.

### <3-2. System Controller>

The system controller 50 includes the CPU 51, ROM 52, RAM 53, an operation I/F 54, storage 55, image memory 56, and an image processing unit 57.

The CPU 51 provides various functions for controlling job execution by the printer 100 and the scanner 200 by executing a control program stored in the ROM 52. The RAM 53 provides the CPU 51 with a temporary storage area for computations. In the present embodiment, the CPU 51 cooperates with the CPU 251 of the scanner controller 250 and provides an ACS function to determine whether to process the document read by the scanner 200 as a colored document or a colorless document. For the ACS function, the CPU 51 operates as a second determination unit 60.

The operation I/F 54 is an interface for connecting the system controller 50 to the operation unit 10. The storage 55 may be a storage apparatus including a non-volatile storage medium such as a hard disk drive (HDD), for example. The storage 55 may be used for storing read image data generated as the result of a scan job, for example.

The image memory 56 temporarily stores image data exchanged between the system controller 50 and the printer 100, the scanner 200, or an external apparatus. The image processing unit 57 converts the format of the image data to a format suitable for the apparatus to which the image data is output. For example, in the case of a copy job, the image processing unit 57 receives read image data of the document read by the scanner 200 from the scanner controller 250 and converts the received read image data to data suitable for an image-forming operation by the printer 100. Also, in the case of a scan job, the image processing unit 57 converts the read image data received from the scanner controller 250 to data suitable for storage by the storage 55 or transmission to an external apparatus. Accordingly, the printer 100 may be considered an image processing apparatus.

Transmission of read image data from the scanner controller 250 to the system controller 50 via the image signal line L2 may be performed in synchronization with each reading of one line of image. In this case, the CPU 251 outputs a vertical synchronization signal indicating the transmission timing of the leading line of each page and a horizontal synchronization signal indicating the transmission timing of the leading pixel of each line to the CPU 51 via the control signal line L1. The CPU 51 controls the image processing unit 57 so that the read image data is received using the vertical synchronization signal and the horizontal synchronization signal as a reference.

Note that any part of the control functions described in the present specification may be implemented by hardware using a dedicated circuit instead of being implemented by software using a general-purpose processor such as the CPU described above or a microcontroller.

### 4. ACS

In the present embodiment, the ACS function of the document-reading system 1 is provided by the first determination unit 260 of the scanner controller 250 and the second determination unit 60 of the system controller 50. The first determination unit 260 performs ACS primary determination and notifies the second determination unit 60 of the result. The second determination unit 60 performs secondary determination on the basis of a user input in a case where the primary determination cannot determine with sufficient certainty whether the document is colored or colorless.

### <4-1. Primary Determination>

The first determination unit 260, in the primary determination, calculates a numerical measure based on the color component values of the pixels forming the read image data and determines whether or not the calculated numerical measure is within a range defined by a predetermined upper limit and lower limit. For example, the numerical measure may be a measure indicating a value that increases when the chroma of the image is higher or when the ratio of pixels with high chroma is higher. In such a case, if the numerical measure is greater than the upper limit of the range described above, the first determination unit 260 determines the document to be colored, and if the numerical measure is less than the lower limit of the range described above, the first determination unit 260 determines the document to be colorless. Alternatively, the numerical measure may be a measure indicating a value that decreases when the chroma of the image is higher or when the ratio of pixels with high chroma is higher. In such a case, the result of the primary determination is the reverse of the example described above. The first determination unit 260 determines that an inquiry to the user is required as to whether to process the document as a colored document or a colorless document when the numerical measure is within the range described above since the certainty in the stereotypical determination is insufficient. Hereinafter, the numerical measure described above is referred to as a chroma-related measure, and the range described above is referred to as an uncertainty range. The first determination unit 260 notifies the second determination unit 60 of the result of the primary determination based on a comparison between the chroma-related measure and the uncertainty range.

The chroma-related measure, for example, may include at least one of the number of colored pixels or colored pixel blocks in the read image, the ratio of colored pixels or colored pixel blocks, a color component value other than brightness, and the number of consecutive colored pixels in a specific direction in the read image. Specific examples of chroma-related measures will be described below.

In a first example, the chroma-related measure may represent the number of colored pixels in the read image. Specifically, for each pixel in the read image, the first determination unit 260 calculates the chroma from the RGB component value according to the conversion formula described in Japanese Patent Laid-Open No. 2018-129861 and compares the calculated chroma to a predetermined threshold to categorize the pixels as either colored pixels or colorless pixels. Then, the first determination unit 260 counts the number of pixels categorized as colored pixels in the read image. In the first example, in a case where the uncertainty range compared to a number of colored pixels Nc is in a range from 95 to 100, for example, the primary determination result is as follows:

$$\begin{matrix}{N}_{C} < 95 & \to Document is colorless \\ 95 \leq {N}_{C} < 100 & \to User inquiry required \\ 100 \leq {N}_{C} & \to Document is colored\end{matrix}$$

In a case where the uncertainty range is in a range from 100 to 105, for example, the primary determination result is as follows:

$$\begin{matrix}{N}_{C} < 100 & \to Document is colorless \\ 100 \leq {N}_{C} < 105 & \to User inquiry required \\ 105 \leq {N}_{C} & \to Document is colored\end{matrix}$$

As an application example of the first example, the chroma-related measure may represent the ratio (Nc/NALL) of the number Nc of colored pixels to the total number of pixels NALL in the read image.

In a second example, the chroma-related measure may represent the number of colored pixel blocks in the read image. Specifically, the first determination unit 260 segments the read image into a plurality of pixel blocks with a uniform size and counts the number of colored pixels in each pixel block in a similar manner to that in the first example. Also, by comparing the number of colored pixels in each pixel block to a predetermined threshold, the first determination unit 260 categorizes each pixel block into either a colored pixel block or a colorless pixel block. Then, by comparing the number of colored pixel blocks in the read image with a predetermined uncertainty range, the first determination unit 260 determines whether the document is colorless, whether a user inquiry is required, or whether the document is colored. In an application example of the second example, the chroma-related measure may represent the ratio of the number of colored pixel blocks to the total number of pixel blocks in the read image.

In a third example, the chroma-related measure may represent one or two color component values other than brightness. The chroma in the first example described above is an example of a color component other than brightness. Alternatively, a-component and b-component or a* component and b* component of a three-dimensional vector of Lab color space or L*a*b color space that may be derived from the RGB component values correspond to an example of two color components other than brightness (L). In the case of using Lab color space, the primary determination can be performed under the following condition, for example. Note that the operator ∥ means an absolute value.

$$\begin{matrix}\vert a \vert < 9.4 and \vert b \vert < 9.4 & \to Colorless pixel \\ Except for the foregoing , \vert a \vert < 10.6 and \vert b \vert < 10.6 & \\ & \to User inquiry required \\ 10.6 \leq \vert a \vert or 10.6 \leq \vert b \vert & \to Colored pixel\end{matrix}$$

For example, the first determination unit 260 may perform determination on the conditions described above for the pixel with the largest two-dimensional vector constituted by the two color components other than brightness in the read image.

In a fourth example, the chroma-related measure may represent the number of consecutive colored pixels in a specific direction. Specifically, similarly to the first example, the first determination unit 260 categorizes each pixel in the read image into either a colored pixel or a colorless pixel. Next, according to the method described in Japanese Patent Laid-Open No. 2008-306396, the first determination unit 260 counts the number of consecutive colored pixels in a specific direction (for example, the sub-scanning direction) in the read image. Then, by comparing the (maximum) number of consecutive colored pixels in the specific direction with a predetermined uncertainty range, the first determination unit 260 determines whether the document is colorless, whether a user inquiry is required, or whether the document is colored.

In a certain modified example, in a case where the chroma-related measure is within the uncertainty range, the first determination unit 260 may tentatively determine whether to process the document as a colored document or a colorless document. Specifically, in a case where the chroma-related measure is within the uncertainty range, the first determination unit 260 may tentatively determine to process the document as a colored document. Alternatively, in a case where the chroma-related measure is within the uncertainty range, the first determination unit 260 may tentatively determine to process the document as a colorless document. As an example, assume that a determination threshold compared with the number Nc of colored pixels in a conventional ACS is equal to one hundred. With this determination threshold as a reference, the uncertainty range may be set to a range from 100 to 105, and if the number Nc is within the uncertainty range, the first determination unit 260 may tentatively determine that the document is to be processed as a colored document and also determine that user inquiry is required in the secondary determination. Alternatively, with the above determination threshold as a reference, the uncertainty range may be set to a range from 95 to 100 and, if the number Nc is within the uncertainty range, the first determination unit 260 may tentatively determine that the document is to be processed as a colorless document and also determine that user inquiry is required in the secondary determination.

In another modified example, the uncertainty range may be divided into a first uncertainty range and a second uncertainty range using a predetermined reference value (for example, determination threshold=100). In this case, the first determination unit 260 may tentatively determine that the document is to be processed as a colored document if the chroma-related measure is within the first uncertainty range and may tentatively determine that the document is to be processed as a colorless document if the chroma-related measure is within the second uncertainty range. Specifically, the primary determination based on the number Nc of colored pixels may be performed as follows:

$$\begin{matrix}{N}_{C} < 95 & \to Determine as colorless \\ 95 \leq {N}_{C} < 100 & \to User Inquiry ( tentatively determine as colorless ) \\ 100 \leq {N}_{C} < 105 & \to User Inquiry ( tentatively determine as colored ) \\ 105 < {N}_{C} & \to Determined as colored\end{matrix}$$

In this example, the first uncertainty range is a range from 100 to 105, the second uncertainty range is a range from 95 to 100, and the reference value is 100. Such a tentative determination result may be displayed on a screen when the second determination unit 60 makes an inquiry to the user as described below, and may be used as a default option that is selected when no user input is obtained.

### <4-2. Secondary Determination>

In a case where the first determination unit 260 determines the chroma-related measure to be within the uncertainty range in the primary determination, the second determination unit 60 determines whether to process the document as a colored document or a colorless document on the basis of a user input accepted by the operation unit 10. Meanwhile, in a case where it is determined that the chroma-related measure is not within the uncertainty range in the primary determination, the second determination unit 60 determines whether to process the document as a colored document or a colorless document from the result of the primary determination and not from a user input. In the case of the latter, a document determined to be colored in the primary determination is processed as a colored document, and a document determined to be colorless in the primary determination is processed as a colorless document.

For example, the operation unit 10 of the document-reading system 1 includes a display. In a case where the chroma-related measure is determined to be within the uncertainty range, the second determination unit 60 may display a preview of the read image of the document on the display of the operation unit 10 and may allow the user to select on the screen whether to process the document as a colored document or a colorless document. The user can recall the content of the document by looking at the displayed preview and appropriately determine whether to select colored or colorless. The second determination unit 60 may display a preview of a first read image of the document read as a colored document and a preview of a second read image of the document read as a colorless document on the display (for example, side by side). The user can visually compare the previews of the two types and accurately determine whether to select colored or colorless.

In the modified example described above of the primary determination, in a case where the first determination unit 260 tentatively determines whether to process the document as a colored document or a colorless document, the second determination unit 60 may display the tentative determination result on the screen for displaying the user inquiry. In such a case, when a user input is not detected after a predetermined duration of time, the second determination unit 60 may use the tentative determination result as the final result and proceed with the subsequent processing without further waiting for a user input. In this manner, as the user does not necessarily need to perform an additional operation or input, the burden of the task on the user can be reduced.

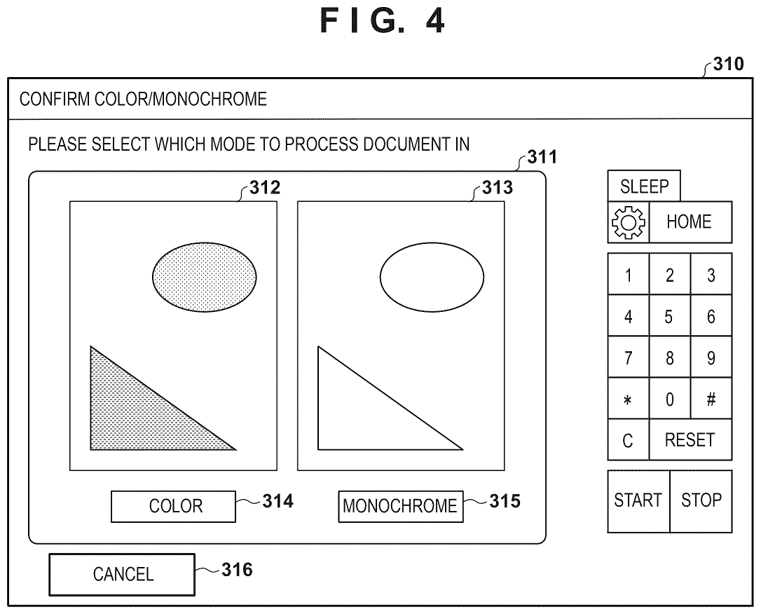

FIG. 4 is an explanatory diagram of a configuration of a mode selection screen that may be displayed on the display in the secondary determination according to the first example. As illustrated in FIG. 4, a mode selection screen 310 includes a preview region 311 and a cancel button 316. The preview region 311 includes a first preview 312, a second preview 313, a color select button 314, and a monochrome select button 315. The first preview 312 represents a preview of the first read image obtained when the document is read as a colored document. The second preview 313 represents a preview of the second read image obtained when the document is read as a colorless document. In a case where the user looks at the first preview 312 and the second preview 313 and determines to process the document as a colored document, the user operates the color select button 314. In a case where the user determines to process the document as a colorless document, the user operates the monochrome select button 315. When the color select button 314 is operated, the second determination unit 60 determines to process the document as a colored document and controls the subsequent processing so that the processing proceeds on the basis of the colored read image data (for example, image formation in the color print mode). On the other hand, when the monochrome select button 315 is operated, the second determination unit 60 determines to process the document as a colorless document and controls the subsequent processing so that the processing proceeds on the basis of the colorless read image data (for example, image formation in the monochrome print mode). When the cancel button 316 is operated, the second determination unit 60 closes the mode selection screen 310 and cancels the execution of the job.

Note that in the mode selection screen 310, instead of the first preview 312 and the second preview 313 being displayed side by side, the preview displayed on the screen may be able to be switched between the two previews in response to a user input.

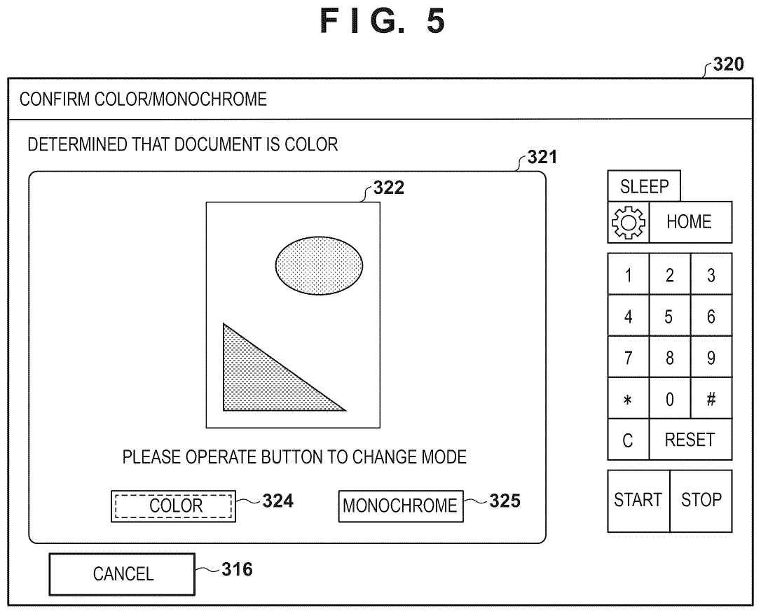

FIG. 5 is an explanatory diagram of a configuration of a mode selection screen that may be displayed on the display in the secondary determination according to the second example. As illustrated in FIG. 5, a mode selection screen 320 includes a preview region 321 and the cancel button 316. The preview region 321 includes a preview 322, a color select button 324, and a monochrome select button 325. In the example of FIG. 5, as the result of the primary determination, it has been tentatively determined to process the document as a colored document. The preview 322 represents a preview of the read image obtained when the document is read as a colored document. In the color select button 324, a dashed line box is provided indicating that, of color and monochrome, color is the default option. If the user looks at the preview 322 and determines to process the document as a colorless document, the user operates the monochrome select button 325. On the other hand, if the user determines to process the document as a colored document, the user operates the color select button 324 or waits without performing an operation. If neither of the buttons are operated, the second determination unit 60 determines that the document is to be processed as a colored document on the basis of the tentative determination result and controls the subsequent processing so that the processing proceeds on the basis of the colored read image data. On the other hand, if the color select button 324 or the monochrome select button 325 is operated, the second determination unit 60 controls the subsequent processing so that the processing proceeds in the corresponding mode.

### <4-3. Transmission of Read Image Data and Primary Determination Result>

When the primary determination is performed by the first determination unit 260, the scanner controller 250 transmits the primary determination result together with the read image data of the document to the system controller 50. The primary determination result may be transmitted to the system controller 50 as a part of page information describing the attributes of the read document. The page information may include one or more of total page count, page number, document size (for example, length in the sub-scanning direction and width in the main scanning direction), and presence of abnormality, for example. The primary determination result may indicate ‘Colored’, ‘Colorless’, or ‘Inquiry Required’ per page.

In a case where the chroma-related measure is determined to be within the uncertainty range, the scanner controller 250 may transmit, to the system controller 50, first read image data generated assuming that the document is colored and second read image data generated assuming that the document is colorless. In this case, the system controller 50 uses one of the first read image data or the second read image data in the subsequent processing according to the result of the secondary determination. For example, in a copy job, if the document is determined to be processed as a colored document on the basis of a user input in the secondary determination, the printer 100 forms a color image on a sheet on the basis of the first read image data. Alternatively, if the document is determined to be processed as a colorless document on the basis of a user input in the secondary determination, the printer 100 forms a monochrome image on a sheet on the basis of the second read image data. In this case, since the printer 100 can immediately start the image formation operation, the waiting time from when a user input is accepted to the end of processing (for example, a copied output of the printing unit) can be minimized.

Note that the primary determination result may be implicitly displayed on the system controller 50 by showing which type of read image data has been provided from the scanner controller 250. For example, a document for which only colored first read image data has been provided may be considered as a colored document, a document for which only a colorless second read image data has been provided may be considered as a colorless document, and a document for which both read image data has been provided may be considered as a document requiring a user inquiry.

Alternatively, in a case where the chroma-related measure is determined to be within the uncertainty range, the scanner controller 250 may transmit only the first read image data generated assuming that the document is colored to the system controller 50. In this case, if the document is determined to be processed as a colored document in the secondary determination, the system controller 50 uses the received first read image data in the subsequent processing (for example, color image formation). On the other hand, if the document is determined to be processed as a colorless document in the secondary determination, the system controller 50 converts the first read image data into second read image data representing the colorless read image and uses the second read image data in the subsequent processing (for example, monochrome image formation). In this case, since the amount of data being transmitted from the scanner 200 to the system controller 50 is reduced, the communication time can be reduced and the overall productivity of job execution can be enhanced.

### 5. Processing Flow

In the present section, some embodiment examples of the processing flows relating to ACS including the primary determination and the secondary determination described above will be described using flowcharts. Note that in each flowchart, “S” denotes a processing step.

### 5-1. First Embodiment Example

In the first embodiment example, it is assumed that only one side of a single document is read by the scanner 200 in a single job.

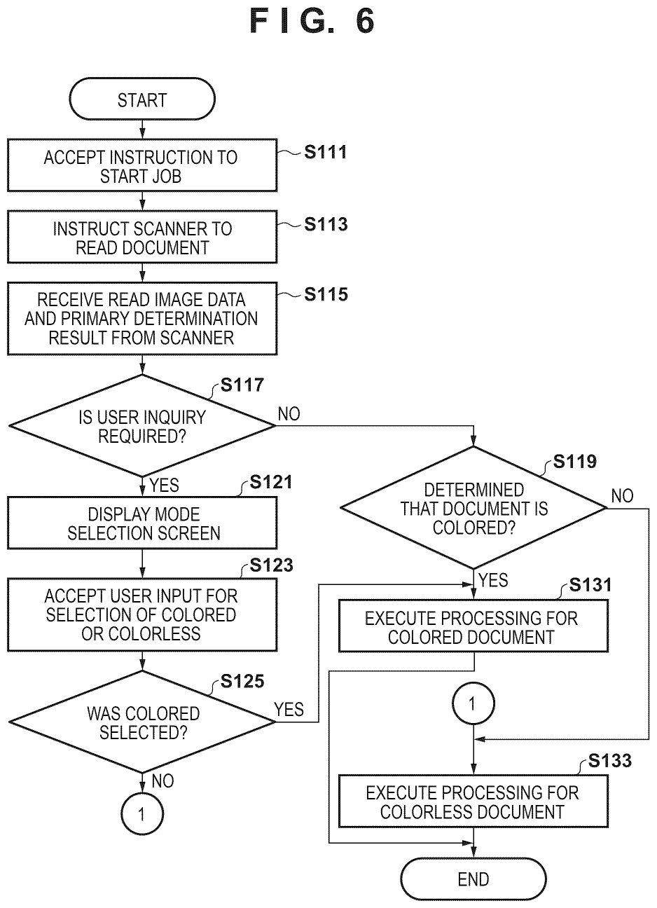

FIG. 6 is a flowchart illustrating an example of a flow of job control processing that may be executed by the system controller 50 in the first embodiment example. The job control processing of FIG. 6 may be started when the user places a document on the platen 203 or sets a document on the document tray 204 and issues the document-reading system 1 with an instruction to execute a job via the operation unit 10.

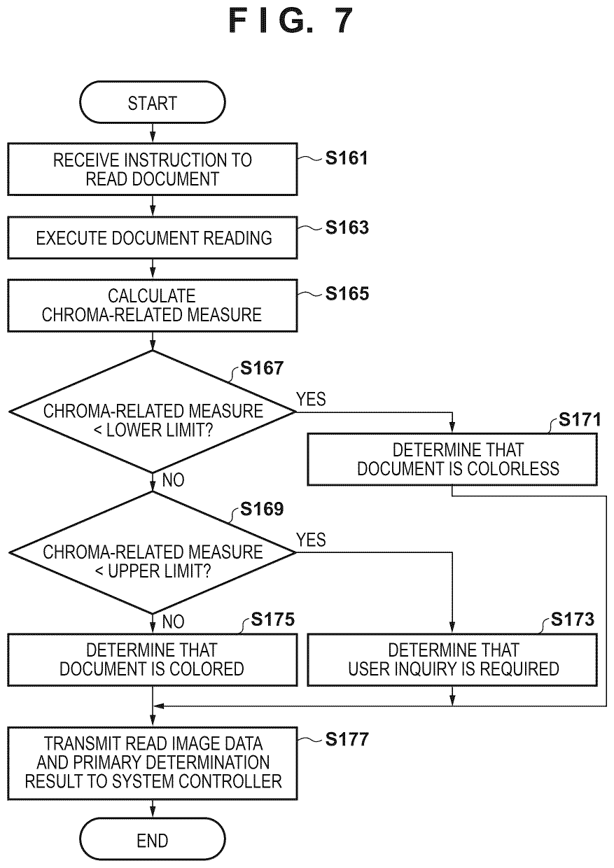

First in S111, the system controller 50 accepts an instruction to start the job from the operation unit 10. In S113, the system controller 50 instructs the scanner 200 to read the document. When the scanner 200 is instructed to read the document, the scanner 200 executes the document reading processing illustrated in FIG. 7.

FIG. 7 is a flowchart illustrating an example of a flow of document reading processing that may be executed by the scanner 200 in the present embodiment example. First, in S161, the scanner controller 250 receives an instruction to read the document from the system controller 50.

Next, in S163, the scanner controller 250 detects the document on the platen 203 or the document tray 204, drives the guide motor or the conveyance motor of the ADF 210, and causes the first reading unit 220 to read the document. The first reading unit 220 reads the first side of the document and generates read image data. The first determination unit 260 obtains the read image data processed by the image processing unit 258.

Next, in S165, the first determination unit 260 calculates the chroma-related measure for the primary determination on the basis of the read image data. Next, in S167 and S169, the first determination unit 260 compares the calculated chroma-related measure with the lower limit and the upper limit of the uncertainty range. The processing thereafter branches depending on the result of the comparison.

In a case where the chroma-related measure is less than the lower limit of the uncertainty range (YES in S167), in S171, the first determination unit 260 determines that the read document is colorless. In a case where the chroma-related measure is equal to or greater than the lower limit of the uncertainty range and less than the upper limit (NO in S167 and YES in S169), in S173, the first determination unit 260 determines that a user inquiry is required regarding the read document. In a case where the chroma-related measure is equal to or greater than the upper limit of the uncertainty range (NO in S169), in S175, the first determination unit 260 determines that the read document is colored.

Next, in S177, the scanner controller 250 transmits the read image data and the result of the primary determination by the first determination unit 260 to the system controller 50. The read image data transmitted here may include the image data of a colored read image and/or the image data of a colorless read image.

Returning to FIG. 6, in S115, the system controller 50 receives the read image data and the result of the primary determination from the scanner 200. The processing thereafter branches at S117 and S119 depending on the result of the primary determination.

In a case where it is determined that a user inquiry is required in the primary determination (YES in S117), in S121, the second determination unit 60 displays the mode selection screen described above on the operation unit 10. Next, in S123, the second determination unit 60 accepts a user input for selection of colored or colorless. The processing thereafter branches at S125 depending on the mode selected by the user. In a case where the user selects colored (color), the processing proceeds to S131. In a case where the user selects colorless (monochrome), the processing proceeds to S133.

In a case where it is determined that the document is colored in the primary determination (NO in S117 and YES in S119) or colored is selected in the secondary determination, in S131, the system controller 50 executes processing for a colored document. For example, the system controller 50 controls the printer 100 so that a color image is formed on a sheet on the basis of the colored read image data or stores the colored read image data in the storage 55 or transmits the colored read image data to an external apparatus.

In a case where it is determined that the document is colorless in the primary determination (NO in S117 and NO in S119) or colorless is selected in the secondary determination, in S133, the system controller 50 executes processing for a colorless document. For example, the system controller 50 controls the printer 100 so that a monochrome image is formed on a sheet on the basis of the colorless read image data or stores the colorless read image data in the storage 55 or transmits the colorless read image data to an external apparatus.

As described above, by determining whether to process the document as a colored document or a colorless document on the basis of a user input in a case where the chroma-related measure is within the uncertainty range, the possibility of an ACS error causing a processing result contrary to the intention of the user can be avoided. Also, since the inquiry to the user is not made unless the chroma-related measure is within the uncertainty range, the user is not bothered with excessive user interactions.

### 5.2 Second Embodiment Example

In the second embodiment example, it is assumed that a plurality of documents are successively read by the scanner 200 in a single job. The first determination unit 260 performs the primary determination by comparing the chroma-related measure to the uncertainty range for each read image of the plurality of documents conveyed by the ADF 210. In a case where the chroma-related measure corresponding to one or more of the plurality of documents is determined to be within the uncertainty range in the primary determination, the second determination unit 60 performs a user inquiry in response to the end of the scanner 200 reading the plurality of documents. Then, the second determination unit 60 determines whether each of the one or more documents determined to have a chroma-related measure within the uncertainty range is colored or colorless on the basis of the corresponding user input (for example, selection on a screen).

The flow of the job control processing that may be executed by the system controller 50 in the present embodiment example may be similar to the flow according to the first embodiment example described using FIG. 6. However, in S115, the second determination unit 60 receives the read image data and the primary determination result for the plurality of documents from the first determination unit 260. In a case where it is determined that a user inquiry is required for the one or more documents as the primary determination result, the mode selection screen display of S121 and the user input acceptance of S123 are performed for each of the one or more documents. Also, the processing of S131 or S133 is executed for each read document.

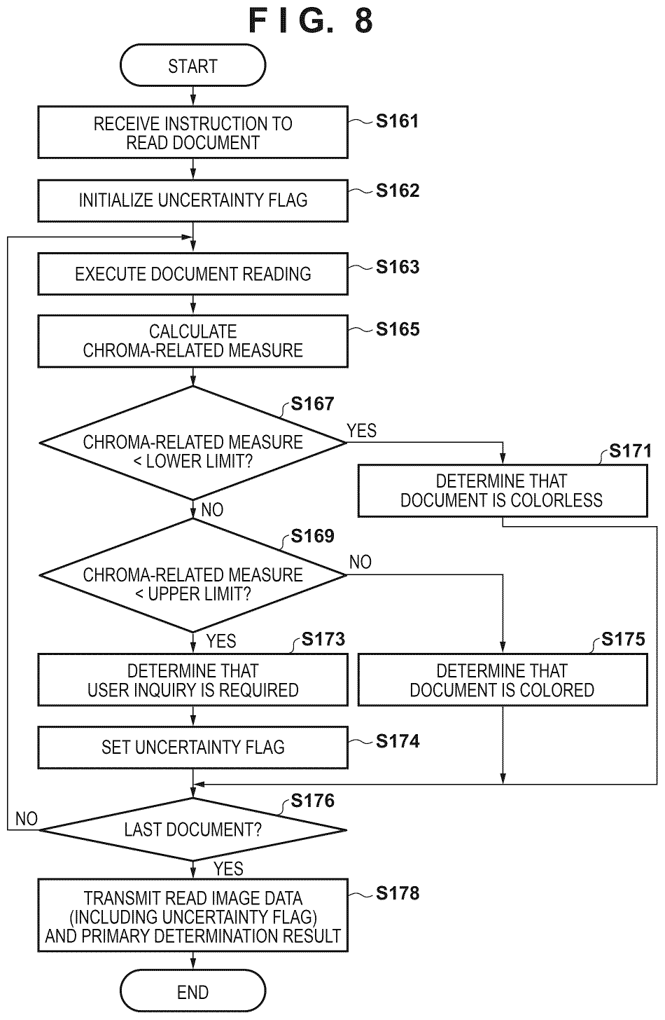

FIG. 8 is a flowchart illustrating an example of a flow of document reading processing that may be executed by the scanner 200 in the present embodiment example. First, in S161, the scanner controller 250 receives an instruction to read the document from the system controller 50. Next, in S162, the first determination unit 260 initializes, for example, sets to zero, an uncertainty flag indicating whether the chroma-related measure has been determined to be within the uncertainty range for at least one of the documents.

Next, in S163, the scanner controller 250 detects the document on the document tray 204, drives the conveyance motor of the ADF 210, and causes the first reading unit 220 to read one of the documents. The first reading unit 220 reads the first side of the document and generates read image data. Next, in S165, the first determination unit 260 calculates the chroma-related measure for the primary determination on the basis of the read image data. Next, in S167 and S169, the first determination unit 260 compares the calculated chroma-related measure with the lower limit and the upper limit of the uncertainty range.

In a case where the chroma-related measure is less than the lower limit of the uncertainty range (YES in S167), in S171, the first determination unit 260 determines that the read document is colorless. In a case where the chroma-related measure is equal to or greater than the lower limit of the uncertainty range and less than the upper limit (NO in S167 and YES in S169), in S173, the first determination unit 260 determines that a user inquiry is required regarding the read document. Also, in S174, the first determination unit 260 changes the uncertainty flag to a value (for example, 1) that indicates that the chroma-related measure has been determined to be within the uncertainty range for at least one of the documents. Note that in a case where the value of the uncertainty flag has already been changed, S174 may be skipped. In a case where the chroma-related measure is equal to or greater than the upper limit of the uncertainty range (NO in S169), in S175, the first determination unit 260 determines that the read document is colored.

Next, in S176, the scanner controller 250 determines whether the reading and primary determination have ended for the last document. In a case where there is a document remaining for which reading and primary determination have not ended, the processing returns to S163, and S163 to S174 is repeated for the next document. In a case where reading of the primary determination have ended for the last document, the processing proceeds to S178.

In S178, the scanner controller 250 transmits the read image data and the primary determination result (including the uncertainty flag) for the plurality of documents to the system controller 50. As in the first embodiment example, the read image data for each document may include the image data of a colored read image and/or the image data of a colorless read image.

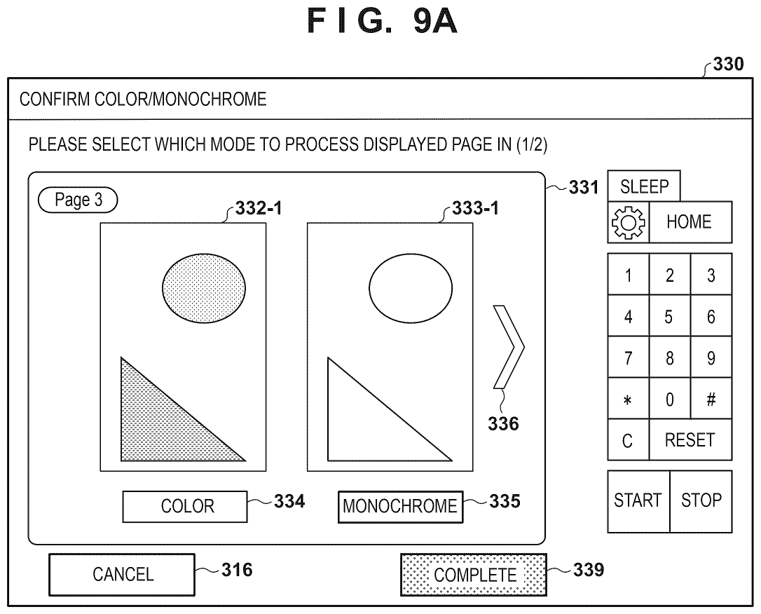

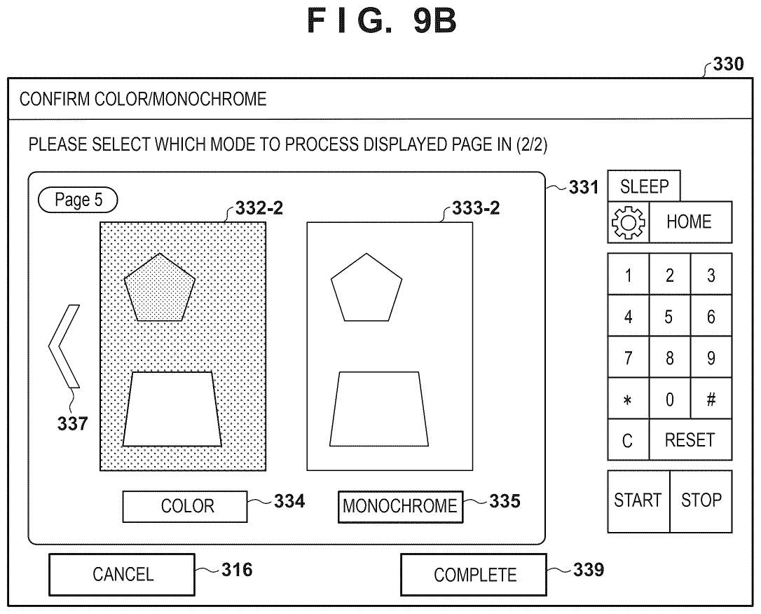

FIGS. 9A and 9B are explanatory diagrams of an example of a configuration of a mode selection screen that may be displayed on the display in the secondary determination according to the present embodiment example. As illustrated in FIG. 9A, a mode selection screen 330 includes a preview region 331, the cancel button 316, and a complete button 339. The preview region 331 includes a first preview 332-1, a second preview 333-1, a color select button 334, a monochrome select button 335, and a page transition button 336.

Herein, assume that, in the primary determination, it has been determined that a user inquiry is required since the chroma-related measure is within the uncertainty range for two pages of the plurality of documents. The first preview 332-1 and the second preview 333-1 in FIG. 9A represent a colored preview and a colorless preview of the first document determined to require a user inquiry. In a case where the user determines to process the document as a colored document, the user operates the color select button 334. In a case where the user determines to process the document as a colorless document, the user operates the monochrome select button 335. When the user operates the page transition button 336, the display of the mode selection screen 330 transitions from FIG. 9A to FIG. 9B.

As illustrated in FIG. 9B, the preview region 331 includes a first preview 332-2, a second preview 333-2, the color select button 334, the monochrome select button 335, and a page transition button 337. The first preview 332-2 and the second preview 333-2 in FIG. 9B represent a colored preview and a colorless preview of the second document determined to require a user inquiry. In a case where the user determines to process the document as a colored document, the user operates the color select button 334. In a case where the user determines to process the document as a colorless document, the user operates the monochrome select button 335. When the user operates the page transition button 337, the display of the mode selection screen 330 returns to FIG. 9A from FIG. 9B.

When selection by the user is performed for all of the documents determined to require a user inquiry, the complete button 339 is enabled (the greying out as illustrated in FIG. 9A is removed, for example). When the user operates the complete button 339, the second determination unit 60 closes the mode selection screen 330 and controls the subsequent processing on the basis of the result of the secondary determination for each document.

Note that the mode selection screen 330 may be provided with a button or other object for collectively selecting colored or colorless (color or monochrome) for all of the documents determined to require a user inquiry.

According to the second embodiment example, by collectively performing a user inquiry in response to the successive reading of a plurality of documents having ended, the user can efficiently confirm the contents of the documents and select colored or colorless.

### 5-3. Third Embodiment Example

In the third embodiment example also, it is assumed that a plurality of documents are successively read by the scanner 200 in a single job. In response to each of the plurality of documents conveyed by the ADF 210 being read, the first determination unit 260 performs the primary determination by comparing the chroma-related measure of the corresponding read image to the uncertainty range. In a case where the chroma-related measure is determined to be within the uncertainty range in the primary determination for a certain document, the scanner controller 250 suspends the reading of the subsequent document until the second determination unit 60 determines whether the document is colored or colorless on the basis of a user input. While the reading of the subsequent document is suspended, the second determination unit 60 makes an inquiry to the user as to whether the document determined to have a chroma-related measure within the uncertainty range is colored or colorless and accepts the corresponding user input (for example, a selection on a screen).

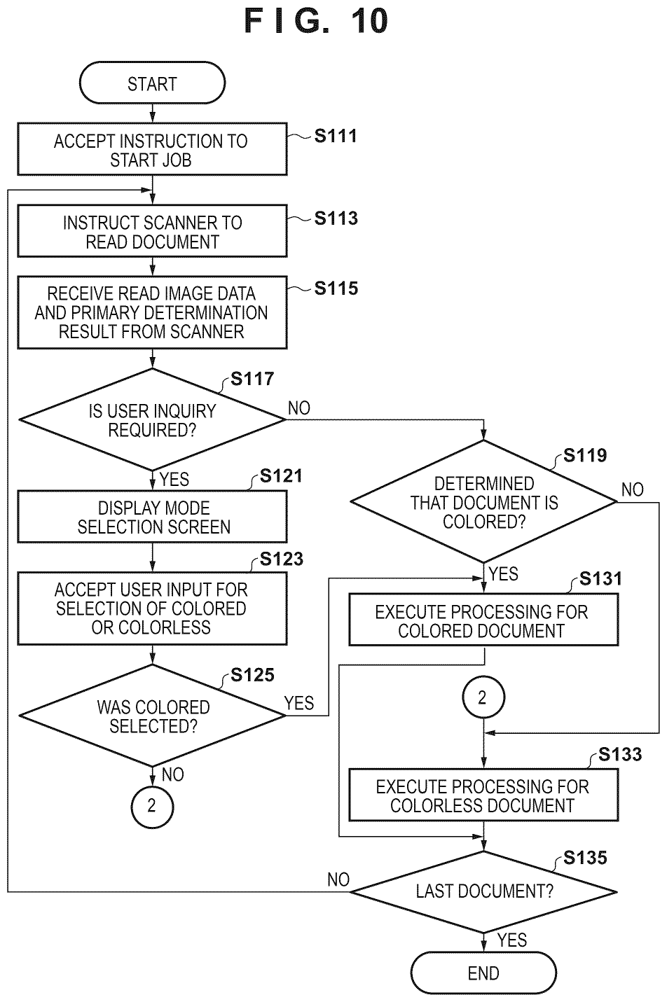

FIG. 10 is a flowchart illustrating an example of a flow of job control processing that may be executed by the system controller 50 in the present embodiment example. The job control processing of FIG. 10 may be started when the user sets a bundle of the plurality of documents on the document tray 204 and issues the document-reading system 1 with an instruction to execute a job via the operation unit 10.

First in S111, the system controller 50 accepts an instruction to start the job from the operation unit 10. In S113, the system controller 50 instructs the scanner 200 to read the document. When the scanner 200 is instructed to read the document, the scanner 200 executes the document reading processing.

The flow of the document reading processing that may be executed by the scanner 200 in the present embodiment example may be similar to the flow according to the first embodiment example described using FIG. 7. However, after the read image data and the primary determination result are transmitted to the system controller 50 in S177, if a subsequent document still remains, the scanner controller 250 returns to S163 and repeats the reading and primary determination for the subsequent document. In a case where it is determined that a user inquiry for whether a certain document is colored or colorless is required, the scanner controller 250 suspends the processing of the subsequent document until the secondary determination based on a user input for this document has ended.

In S115, the system controller 50 receives the read image data and the result of the primary determination for one of the plurality of documents from the scanner 200. In a case where it is determined that a user inquiry is required in the primary determination (YES in S117), in S121, the second determination unit 60 displays the mode selection screen on the operation unit 10. Next, in S123, the second determination unit 60 accepts a user input for selection of colored or colorless. In a case where the user selects colored, the processing proceeds to S131. In a case where the user selects colorless, the processing proceeds to S133.

In a case where it is determined that the document is colored in the primary determination (NO in S117 and YES in S119) or colored is selected in the secondary determination, in S131, the system controller 50 executes processing for a colored document. In a case where it is determined that the document is colorless in the primary determination (NO in S117 and NO in S119) or colorless is selected in the secondary determination, in S133, the system controller 50 executes processing for a colorless document.

Next, in S135, the system controller 50 determines whether the document reading and secondary determination have ended for the last document. In a case where a subsequent document remains, the processing returns to S113 and S113 to S133 are repeated for the next document. In a case where no subsequent document remains, the job control processing of FIG. 10 ends.

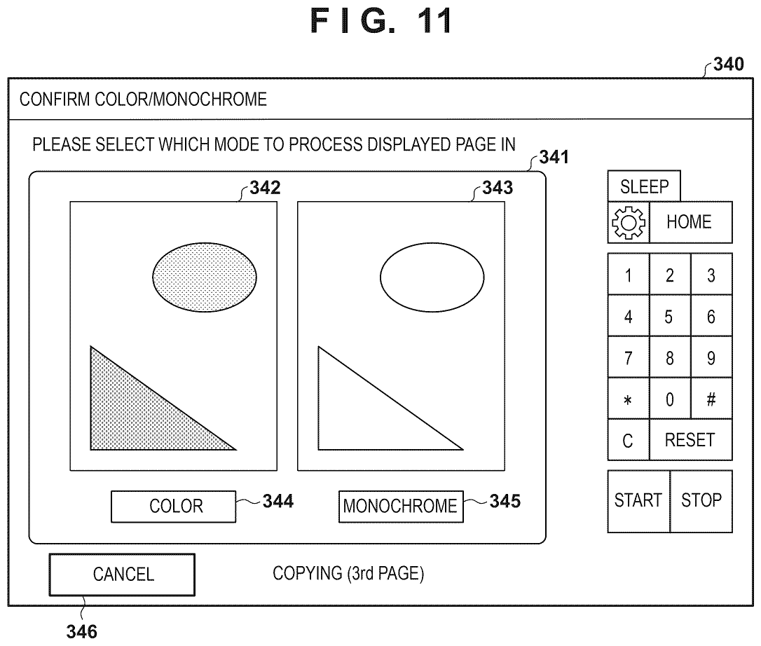

FIG. 11 is an explanatory diagram of an example of a configuration of a mode selection screen that may be displayed on the display in the secondary determination according to the present embodiment example. As illustrated in FIG. 11, a mode selection screen 340 includes a preview region 341 and a cancel button 346. The preview region 341 includes a first preview 342, a second preview 343, a color select button 344, and a monochrome select button 345.

Herein, assume that it has been determined that a user inquiry is required since the chroma-related measure is within the uncertainty range for the third document (third page) of the plurality of documents that are the target of the copy job. The first preview 342 and the second preview 343 in FIG. 11 represent a colored preview and a colorless preview of the document. In a case where the user determines to process the document as a colored document, the user operates the color select button 344. In a case where the user determines to process the document as a colorless document, the user operates the monochrome select button 345. When the color select button 344 is operated, the second determination unit 60 determines to process the document as a colored document and controls the subsequent processing so that the processing proceeds on the basis of the colored read image data. On the other hand, when the monochrome select button 345 is operated, the second determination unit 60 determines to process the document as a colorless document and controls the subsequent processing so that the processing proceeds on the basis of the colorless read image data. When the cancel button 346 is operated, the second determination unit 60 cancels the execution of the copy job. The scanner controller 250 is notified that these operations have been performed.

Note that the mode selection screen 340 may be provided with a button or another object for the user to designate to apply the same selection to all of the subsequent documents determined to require a user inquiry.

As for copy jobs, since images are formed on sheets by the printer 100 on the basis of read image data, the processing for subsequent documents cannot be proceeded to until there is a user input to select colored or colorless for a document with an uncertain ACS determination. This is not the case with scan jobs which will end with storage or external transmission of read image data. Accordingly, the third embodiment example described above in which an inquiry is immediately made to the user for a document with an uncertain ACS determination is particularly suitable for copy jobs.

### 6. Modified Example

In a modified example of the various embodiment examples described above, the operation unit 10 may accept a setting for enabling or disabling a user inquiry relating to whether to process a document as a colored document or a colorless document. In the modified example, a first mode or a second mode is set in the second determination unit 60 on the basis of a user input accepted by the operation unit 10. In the first mode, user inquiry is enabled. In this case, when a chroma-related measure is determined to be within the uncertainty range, the second determination unit 60 performs a user inquiry for whether to process the document as a colored document or a colorless document and performs determination based on the user input described above. In the second mode, user inquiry is disabled. In this case, the first determination unit 260 determines whether the document is colored or colorless by comparing the chroma-related measure of the read image of the document with a predetermined reference value (in other words, the chroma-related measure is not compared with the uncertainty range). The second determination unit 60 determines to process a document determined to be colored in the primary determination as a colored document and determines to process a document determined to be colorless in the primary determination as a colorless document without making a user inquiry.

According to such a modified example, the ACS operations can be flexibly set to match the user's needs. For example, a user that wishes to reduce instances of color being selected that is contrary to his or her intention can enable the inquiry and select the appropriate mode when the ACS determination is uncertain. A user that wishes to increase task productivity can disable the inquiry to cut UI operations and enable jobs to be completed earlier.

In the modified example described above, on the basis of a reference value of a determination for the case of user inquiry being disabled, at least one of the upper limit and the lower limit of the uncertainty range may be set. For example, the reference value compared with the number Nc of colored pixels may be equal to 100. In a case where user inquiry is disabled, if the number Nc is less than 100, the document may be determined to be colorless, and if the number Nc is equal to or greater than 100, the document may be determined to be colored. In a case where user inquiry is enabled, the uncertainty range may be set to 95 to 105 by adding an offset of +5% to the reference value. Accordingly, when the number Nc is equal to or greater than 95 and less than 105, it may be determined that a user inquiry is required regarding whether the document is colored or colorless. Such an offset may be able to be set by the user. In this manner, the user can adjust the frequency at which they are inquired about whether the document is colored and colorless due to the ACS determination being uncertain.

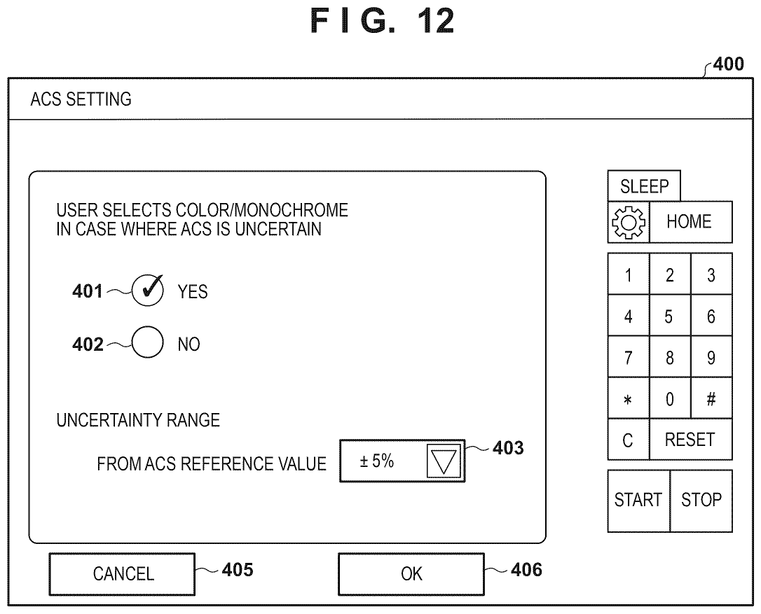

FIG. 12 is an explanatory diagram of an example of a configuration of an ACS settings screen according to the present modified example. As illustrated in FIG. 12, an ACS settings screen 400 includes radio buttons 401 and 402, an offset input field 403, a cancel button 405, and an OK button 406. In a case where the user wishes to make the selection when the chroma-related measure is in the uncertainty range in ACS, the user checks the radio button 401. Otherwise, the user checks the radio button 402. When the radio button 401 is checked, user inquiry is enabled and operation of the offset input field 403 is enabled (first mode). The user can set the numerical value of the offset for setting the upper limit and the lower limit of the uncertainty range on the basis of the reference value in the offset input field 403. When the radio button 402 is checked, user inquiry is disabled (second mode). To cancel the changes to the settings, the user operates the cancel button 405. When the user operates the OK button 406, the changes made to the settings on the ACS settings screen 400 are applied to the subsequent operations of the first determination unit 260 and the second determination unit 60.

### 7. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-109089, filed on Jul. 5, 2024 which is hereby incorporated by reference herein in its entirety.

What is claimed is:

1. A document-reading system comprising:
an operation unit configured to accept a user input;
a reading unit configured to read a document and generate read image data;
a first determination unit configured to determine whether a numerical measure that is based on a color of a pixel of the read image data is within a predetermined range; and
a second determination unit configured to determine whether the document is to be processed as a colored document or a colorless document,
wherein the second determination unit is configured to, based on a user input accepted by the operation unit, perform determination in a first mode in which an inquiry to a user is made as to whether to process the document as a colored document or a colorless document in a case where the first determination unit has determined that the numerical measure is within the range or in a second mode in which whether to process the document as a colored document or a colorless document is determined without making the inquiry.

2. The document-reading system according to claim 1, wherein the operation unit includes a display, and
in a case where the first determination unit has determined that the numerical measure is within the range in the first mode, the second determination unit is configured to display a preview of a read image of the document on the display and allows a user to select whether to process the document as a colored document or a colorless document.

3. The document-reading system according to claim 2, wherein, in a case where the first determination unit has determined that the numerical measure is within the range in the first mode, the second determination unit is configured to display, on the display, a preview of a first read image of a case where the document is read as a colored document and a preview of a second read image of a case where the document is read as a colorless document.

4. The document-reading system according to claim 2, wherein, in a case where it is determined that the numerical measure is within the range in the first mode, the first determination unit is configured to perform a tentative determination on whether to process the document as a colored document or a colorless document, and
the second determination unit is configured to display a result of the tentative determination on the display.

5. The document-reading system according to claim 1, wherein the reading unit is capable of successively reading a plurality of documents, and
in a case where the first determination unit has determined that the numerical measure for one or more documents of the plurality of documents is within the range in the first mode, the second determination unit is configured to make the inquiry to the user as to whether each of the one or more documents is colored or colorless in response to reading of the plurality of documents by the reading unit ending.

6. The document-reading system according to claim 1, wherein the reading unit is capable of successively reading a plurality of documents,
the first determination unit is configured to, in response to each of the plurality of documents being read by the reading unit, determine whether or not the corresponding numerical measure is within the range, and
in a case where the first determination unit has determined that the numerical measure is within the range for a certain document in the first mode, the reading unit is configured to suspend reading of a subsequent document until the second determination unit determines whether to process the certain document as a colored document or a colorless document.

7. The document-reading system according to claim 1, wherein
the first determination unit is configured to, in the second mode, determine whether to process the document as a colored document or a colorless document by comparing the numerical measure with a predetermined reference value.

8. The document-reading system according to claim 7, wherein at least one of an upper limit and a lower limit of the range is determined based on the reference value and an offset that can be set by a user.

9. The document-reading system according to claim 1, wherein the numerical measure includes at least one of
the number of colored pixels or colored pixel blocks in a read image,
a ratio of colored pixels or colored pixel blocks in a read image,
a color component value other than brightness, and
the number of consecutive colored pixels in a specific direction in a read image.

10. The document-reading system according to claim 1, wherein the document-reading system includes
a document-reading apparatus that includes the reading unit and the first determination unit, and
an image processing apparatus that is connected to the document-reading apparatus via a signal line and includes the second determination unit.

11. The document-reading system according to claim 10, wherein, in a case where the first determination unit has determined that the numerical measure is within the range, the document-reading apparatus is configured to transmit, to the image processing apparatus, first read image data generated assuming that the document is colored and second read image data generated assuming that the document is colorless, and
the image processing apparatus is configured to
process the first read image data in a case where the second determination unit has determined to process the document as a colored document and
process the second read image data in a case where the second determination unit has determined to process the document as a colorless document.

12. The document-reading system according to claim 10, wherein, in a case where the first determination unit has determined that the numerical measure is within the range, the document-reading apparatus is configured to transmit, to the image processing apparatus, first read image data generated assuming that the document is a colored document, and
the image processing apparatus is configured to
process the first read image data in a case where the second determination unit has determined to process the document as a colored document and
convert the first read image data into second read image data representing a colorless read image and process the second read image data in a case where the second determination unit has determined to process the document as a colorless document.

13. The document-reading system according to claim 11, wherein the image processing apparatus processing the first read image data or the second read image data includes at least one of
forming an image on a sheet based on the first read image data or the second read image data,
storing the first read image data or the second read image data in a storage apparatus, and
transmitting the first read image data or the second read image data to an external apparatus.
